(19) United States
(12) Patent Application Publication
(10) Pub. No.: US 2026/0253753 A1
(43) Pub. Date: Aug. 27, 2026

(54) Fast Reactor and Fast Reactor Operation Method

(71) Applicant: Hitachi GE Vernova Nuclear Energy, Ltd., Hitachi-shi (JP)

(72) Inventors: Keita ENDO, Hitachi-shi (JP); Hirotaka NAKAHARA, Hitachi-shi (JP)

(21) Appl. No.: 19/544,172

(22) Filed: Feb. 19, 2026

(30) Foreign Application Priority Data
Feb. 27, 2025 (JP) 2025-030124

(51) Int. Cl. G21C 1/02; G21C 7/32

(52) U.S. Cl. CPC G21C 1/028; G21C 7/32

(57) ABSTRACT

An object of the present invention is to provide a fast reactor and a fast reactor operation method capable of suppressing occurrence of freezing of a heat storage material without draining the heat storage material used in a heat storage system connected to the fast reactor when a temperature of a coolant of the fast reactor decreases in an operation mode such as a cold shutdown. A fast reactor according to the present invention includes: a first heat exchanger that performs heat exchange between a primary coolant and a secondary coolant; a second heat exchanger that performs heat exchange between the secondary coolant and a heat storage material used in a heat storage system; a first pipe through which the secondary coolant flows from the first heat exchanger toward the second heat exchanger; a second pipe through which the secondary coolant flows from the second heat exchanger toward the first heat exchanger; and a bypass pipe that is provided at an inlet and an outlet of the second heat exchanger for the secondary coolant and couples the first pipe and the second pipe.

### CLAIM OF PRIORITY

The present application claims priority from Japanese Patent application serial no. 2025-030124, filed on Feb. 27, 2025, the content of which is hereby incorporated by reference into this application.

### BACKGROUND OF THE INVENTION

### 1. Technical Field

The present invention relates to a fast reactor and a fast reactor operation method.

### 2. Description of the Related Art

Since renewable energy is subject to significant geographical constraints and weather constraints, a power generation amount thereof tends to be unstable. As one of effective means for stably supplying power including such renewable energy, there is a thermal energy storage system having an energy adjustment function.

Examples of heat source candidates include solar power generation and nuclear power generation. As a heat storage system using solar power generation as a heat source, for example, JP 2023-500624 A discloses a self-consumption type next-generation energy-saving heat storage system capable of converting solar energy into thermal storage energy.

On the other hand, as a known example using nuclear power generation as a heat source, there is a nuclear power plant developed by TerraPower, LLC, USA. In the technology, a conventional fast reactor system and a heat storage system using molten salt are combined, so that a nuclear reactor side stores or releases heat generated in a nuclear reactor according to a power market price while continuing rated operation. In a heat storage system using a fast reactor as a heat source, there exist a coolant used in the fast reactor and a material for storing heat used in a heat storage system (hereinafter, referred to as a heat storage material), and heat exchange between both materials is performed by a heat exchanger, which is an interface unit between the fast reactor and the heat storage system.

### SUMMARY OF THE INVENTION

As for an operation of the fast reactor, there is an operation mode (cold shutdown) in which a coolant temperature is lowered to about 200 degrees after a nuclear reactor scram for refueling or the like. The coolant is heated to a high temperature due to a nuclear reaction during the rated operation, but the temperature of the coolant decreases because the nuclear reaction is stopped in the cold shutdown. However, depending on a combination of the coolant and the heat storage material (for example, a combination using sodium or other materials as the coolant and using molten salt or an inexpensive material compatible with an operating range of the fast reactor as the heat storage material), when the temperature of the coolant decreases, the temperature of the heat storage material that exchanges heat with the coolant in the heat exchanger decreases. In a case where the temperature is equal to or lower than a solidification point, the solidified (frozen) heat storage material may block a pipe through which the heat storage material flows. Therefore, it is necessary to take measures to prevent blockage in a case where the temperature of the heat storage material decreases in the operation mode such as the cold shutdown.

As a solution to the above problem, the inventors have considered draining the heat storage material from the heat exchanger before switching from the rated operation to the cold shutdown. However, in this case, when transitioning to the rated operation again, it is necessary to refill the drained heat storage material into the heat exchanger, and a preheating operation is required before the refilling. Therefore, it is considered that an operation switching operation may become complicated, and an operation rate of the plant may decrease.

An object of the present invention is to provide a fast reactor and a fast reactor operation method capable of suppressing occurrence of freezing of a heat storage material without draining the heat storage material used in a heat storage system connected to the fast reactor when a temperature of a coolant of the fast reactor decreases in an operation mode such as a cold shutdown.

According to the present invention, a fast reactor includes: a first heat exchanger that performs heat exchange between a primary coolant and a secondary coolant; a second heat exchanger that performs heat exchange between the secondary coolant and a heat storage material used in a heat storage system; a first pipe through which the secondary coolant flows from the first heat exchanger toward the second heat exchanger; a second pipe through which the secondary coolant flows from the second heat exchanger toward the first heat exchanger; and a bypass pipe that is provided at an inlet and an outlet of the second heat exchanger for the secondary coolant and couples the first pipe and the second pipe.

According to the present invention, a fast reactor operation method for a fast reactor including a first heat exchanger that performs heat exchange between a primary coolant and a secondary coolant, a second heat exchanger that performs heat exchange between the secondary coolant and a heat storage material used in a heat storage system, a first pipe through which the secondary coolant flows from the first heat exchanger toward the second heat exchanger, a second pipe through which the secondary coolant flows from the second heat exchanger toward the first heat exchanger, a bypass pipe that is provided at an inlet and an outlet of the second heat exchanger for the secondary coolant and couples the first pipe and the second pipe, a valve that is configured to adjust a flow rate and provided on the second pipe between the second heat exchanger and a connection portion between the bypass pipe and the second pipe, a third pipe that couples the first pipe and the second pipe, and an air cooler provided on the third pipe includes: stopping operation of the fast reactor; removing heat of the secondary coolant by the air cooler; and opening a valve of the bypass pipe and operating from rated operation to a cold shutdown.

According to the present invention, it is possible to provide the fast reactor and the fast reactor operation method capable of suppressing occurrence of freezing of the heat storage material without draining the heat storage material used in the heat storage system connected to the fast reactor when the temperature of the coolant of the fast reactor decreases in the operation mode such as the cold shutdown.

Problems, configurations, and effects other than those described above will be clarified by the following description of embodiments.

### BRIEF DESCRIPTION OF THE DRAWINGS

FIG. 1 is a configuration diagram of a fast reactor including a molten salt heat storage system during rated operation;

FIG. 2 is a perspective view of a configuration of the fast reactor including the molten salt heat storage system;

FIG. 3 is a configuration diagram of the fast reactor including the molten salt heat storage system during a cold shutdown;

FIG. 4 is a flowchart illustrating a method of operation switching to the cold shutdown for the fast reactor including the molten salt heat storage system; and

FIG. 5 is a configuration diagram of a fast reactor including a molten salt heat storage system.

### DETAILED DESCRIPTION

Hereinafter, embodiments will be described with reference to the drawings. In the following description, a configuration using sodium as a coolant of a fast reactor and using a nitrate mixture, which is often used as a heat storage material for solar power generation, as a heat storage material used in a heat storage system will be described, but the present invention is not limited thereto. The present invention can be applied to a fast reactor including a heat storage system in which freezing of a heat storage material may occur when a temperature of a coolant decreases. In addition, the present invention can be applied regardless of a reactor output such as a small-scale output, a medium-scale output, or a large-scale output, and the number of fast reactors connected to the heat storage system is not limited to one but may be plural. The present invention can be applied regardless of a type of a nuclear fuel loaded into the fast reactor, such as a metal oxide (MOX) fuel or a metal fuel.

### First Embodiment

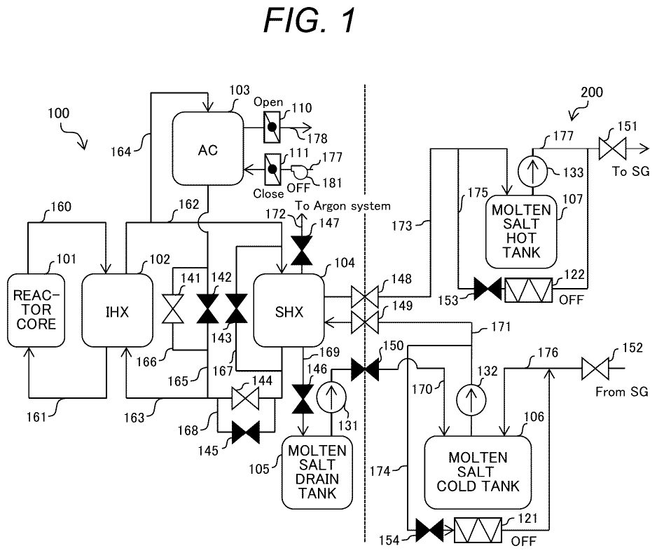

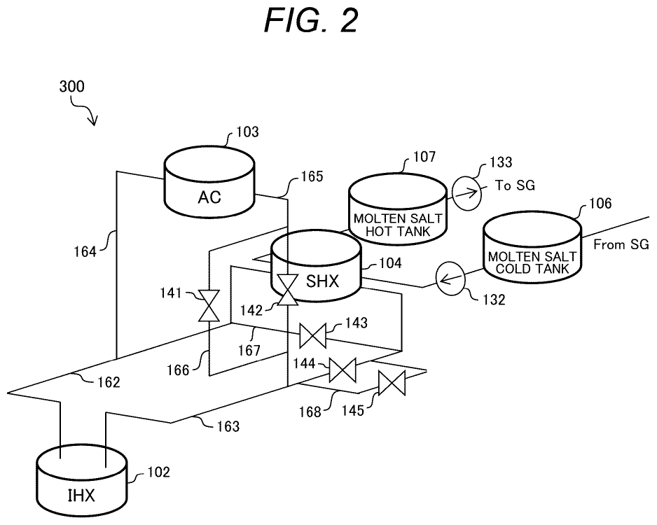

FIG. 1 is a configuration diagram of a fast reactor including a molten salt heat storage system during rated operation. FIG. 2 is a perspective view of a configuration of the fast reactor including the molten salt heat storage system. In both FIGS. 1 and 2, only main devices are illustrated for concise description.

Arrangements of devices and pipes of the fast reactor and the molten salt heat storage system will be described. As illustrated in FIG. 1, a fast reactor 100 includes a reactor core 101, an IHX 102, which is a first heat exchanger (intermediate heat exchanger), an AC 103 which is an air cooler, an SHX 104 which is a second heat exchanger (sodium-molten salt heat exchanger), and a molten salt drain tank 105, and a molten salt heat storage system 200 includes a molten salt cold tank 106 and a molten salt hot tank 107. Molten salt is applied as a heat storage material in a device of the heat storage system. Since the molten salt has a larger heat capacity than oil, a required heat storage material amount and a required tank capacity can be reduced as compared with the oil, which is advantageous in terms of cost and achieves excellent economic efficiency. In addition, a thermal conductivity of the molten salt is also higher than the oil.

A nuclear fuel (not illustrated) is loaded into the reactor core 101. During rated operation of the fast reactor, heat is generated by nuclear fission of the nuclear fuel. The generated heat is transferred toward the IHX 102 by sodium which is a primary coolant present in the reactor core 101.

The IHX 102 is connected to the reactor core 101 via a flow path 160, a primary main circulation pump (not illustrated), and a flow path 161, and is disposed in a nuclear reactor together with the reactor core 101. The above components are not limited to being disposed inside the nuclear reactor, and an arrangement example in which the flow paths 160 and 161 are used as pipes and the primary main circulation pump and the IHX 102 are connected outside the nuclear reactor is also conceivable.

The reactor core 101, the primary main circulation pump, the flow path 160, the flow path 161, and the IHX 102 form a loop (primary loop), and the primary loop is filled with sodium as a primary coolant. The IHX 102 is connected to the SHX 104 via a pipe 162, which is a first pipe, and a pipe 163, which is a second pipe. As illustrated in FIG. 2, the SHX 104 is disposed at a position higher than the IHX 102 in a vertical direction. The IHX 102, the pipe 162, a secondary main circulation pump (not illustrated), the pipe 163, and the SHX 104 also form a loop (secondary loop) similarly to the primary loop, and the secondary loop is filled with sodium as a secondary coolant.

During the rated operation of the fast reactor, in the IHX 102, the primary coolant is in indirect contact with the secondary coolant, and heat generated in the reactor core is transferred from the primary coolant to the secondary coolant. The pipe 163 on an outlet side of the SHX 104 is provided with a valve 144, a pipe 168 that bypasses the valve 144 is provided, and the pipe 168 is also provided with a valve 145. The pipe 168 is a pipe thinner than the pipe 163.

The AC 103 is disposed between the pipe 164 and the pipe 165, which are third pipes, so as to bypass the pipe 162 and the pipe 163 through which the secondary coolant flows. As the air cooler is provided on the third pipes, it is possible to perform a heat removal operation by the AC 103 for the purpose of removing decay heat.

As illustrated in FIG. 2, the AC 103 is disposed at a position higher than the SHX 104 in the vertical direction. That is, the IHX 102, the SHX 104, and the AC 103 are disposed at progressively higher positions in this order. A connection point between the pipe 163 and the pipe 165 is positioned downstream of a connection point between the valve 144 and the pipe 163 and the pipe 168 in a direction in which the secondary coolant flows. A valve 142 is provided on the pipe 165 on an outlet side of the AC 103, and a pipe 166 that bypasses the valve 142 is provided. The pipe 166 is also provided with a valve 141. The pipe 166 is a pipe thinner than the pipe 165.

The AC 103 has an inflow port and an outflow port for external air, a duct 177 provided with a blower 181 and a damper 111 is provided on an inlet side, and a duct 178 provided with a damper 110 is provided on an outlet side.

In addition to the pipe 164 and the pipe 165 on which the AC 103 bypasses, a bypass pipe 167 that bypasses an inlet side and an outlet side of the SHX 104 is provided in parallel, and a bypass valve 143 is provided on the bypass pipe 167.

The AC 103 and the bypass pipe 167 may be arranged in series. The bypass valve 143 is closed during a normal operation, and the bypass valve 143 is opened and the valve 142 and the like are throttled to limit a flow rate to the SHX 104 during a cold shutdown.

In FIG. 1, the bypass pipe 167 is disposed so as to be positioned on substantially the same plane as the SHX 104. However, the present invention is not limited to such a pipe arrangement, and as illustrated in FIG. 2, the pipe 162 and the pipe 163 are bent vertically upward at connection points with the bypass pipe 167. A pipe arrangement in which the SHX 104 is positioned at a position higher than a plane of the secondary loop in the vertical direction is preferable. As the SHX 104 is disposed vertically above the pipe 164 that bypasses, natural circulation can be used, a flow of cold Na is suppressed, and an effect of limiting an inflow amount can be expected.

It is sufficient if a pipe connected to the SHX 104 is positioned above the bypass pipe 167, and the pipe 162 and the pipe 163 are not bent at the connection points with the bypass pipe 167, and instead, the bypass pipe 167 may be bent vertically downward at the connection points. As described below, the bypass pipe 167 is preferably thicker than the other pipes in consideration of a pressure loss.

The SHX 104 is connected to the molten salt cold tank 106 and the molten salt hot tank 107 via a pipe 171 and a pipe 173, respectively. The heat storage material flows from the molten salt cold tank 106 into the SHX 104 through the pipe 171, and flows to the molten salt hot tank 107 through the pipe 173. In the SHX 104, the secondary coolant and the heat storage material are in indirect contact with each other, heat is exchanged between the secondary coolant and the heat storage material, and heat generated in the reactor core is transferred from the secondary coolant to the heat storage material. That is, heat is transferred from the fast reactor 100 to the molten salt heat storage system 200, and heat generated in the fast reactor 100 is stored in the molten salt heat storage system 200.

The molten salt cold tank 106 is connected to a steam generator (SG) via a pipe 176. The heat storage material after heat release at the SG flows from the SG through the pipe 176 and is stored in the molten salt cold tank 106. On the pipe 171, a pump 132 is provided on an outlet side of the molten salt cold tank 106, and a valve 149 is provided on the inlet side of the SHX 104. A valve 152 is provided on the pipe 176 that connects the SG to the molten salt cold tank 106.

The molten salt hot tank 107 is connected to the SG via a pipe. The heat storage material after heat exchange with the secondary coolant in the SHX 104 flows into the molten salt hot tank 107 from the SHX 104 through the pipe 173 and is stored. A valve 148 is provided on the outlet side of the SHX 104, and a pump 133 and a valve 151 are provided on a pipe on an outlet side of the molten salt hot tank 107.

As systems for heating the heat storage material in the molten salt cold tank 106 and the molten salt hot tank 107, a pipe 174 and a pipe 175 are provided, respectively. A valve 154 and a heater 121 are provided on the pipe 174, and a valve 153 and a heater 122 are provided on the pipe 175. A connection point between the pipe 174 and the pipe 171 is between the pump 132 and the valve 149 on the pipe 171, and a connection point between the pipe 174 and the pipe 176 is positioned downstream of the valve 152. A connection point between the pipe 175 and the pipe 173 is positioned downstream of the valve 148, and a connection point between the pipe 175 and the pipe is between the pump 133 and the valve 151.

The molten salt drain tank 105 is connected to the SHX 104 via a pipe 169 and is connected to the molten salt cold tank 106 via a pipe 170. The molten salt drain tank 105 allows the heat storage material to be drained from the SHX 104 to remove the heat storage material. The molten salt drain tank 105 is mainly used at the time of maintenance and preservation work for the SHX. A valve 146 is provided on the pipe 169, and a valve 147 is provided on the pipe 171, and the heat storage material can be drained by opening the valves 146 and 147. Thereafter, the drained heat storage material can be transferred to the molten salt cold tank 106 by turning on a pump 131 disposed on the pipe 170 and opening a valve 150.

As illustrated in FIG. 1, a nuclear power system (fast reactor 100) and an energy system (molten salt heat storage system 200) are divided by the valve 148, the valve 149, and the valve 150. As a result, a radioactive management area can be only the fast reactor 100, and a radioactive management range can be limited.

The rated operation of the fast reactor will be described. During the rated operation, heat generated in the reactor core 101 is transferred from the primary coolant to the secondary coolant in the IHX 102, and further transferred from the secondary coolant to the heat storage material in the SHX 104, and the heated heat storage material is stored in the molten salt hot tank 107. When the heat storage system releases heat due to a decrease in a supply amount of power generated using renewable energy, a discharge pressure of the pump 133 is increased to increase a flow rate of the heat storage material flowing from the molten salt hot tank 107 toward the SG and increase a steam generation amount in the SG. As a result, a power generation amount is increased. Conversely, when the heat storage system is caused to store heat according to an increase in the supply amount of power generated using the renewable energy, the discharge pressure of the pump 133 is reduced.

The valves of the pipes of the fast reactor 100 during the rated operation are operated such that, as illustrated in FIG. 1, the valve 141 and the valve 144 are opened, while the valve 142, the bypass valve 143, the valve 145, the valve 146, and the valve 147 are closed, so that the secondary coolant flows to the AC 103 and the SHX 104. At this time, since the pipe 166 on which the valve 141 is present is a pipe thinner than the pipe 165 and has a large pressure loss, most of the secondary coolant flows toward the SHX 104, and heat generated in the reactor core 101 is transferred to the heat storage material in a tertiary loop. A small amount of secondary coolant flows through the AC 103 from the viewpoint of preventing freezing of sodium, but it is not necessary to cool the secondary coolant during the rated operation, and thus, the blower 181 is turned off and the damper 111 is closed. The valves of the pipes of the molten salt heat storage system 200 are operated such that, as illustrated in FIG. 1, the valve 148, the valve 149, the valve 151, and the valve 152 are opened, while the valve 150, the valve 153, and the valve 154 are closed, so that the entire heat storage material flows through the tertiary loop.

During the rated operation, the secondary coolant flowing into the SHX 104 usually has an inlet-side temperature of about 450 to 500 degrees and an outlet-side temperature of about 300 to 350 degrees, while the heat storage material has an inlet-side temperature of about 300 degrees and an outlet-side temperature of about 450 to 500 degrees. For example, since a solidification point of Solar Salt (a mixture of potassium nitrate and sodium nitrate) often used as a heat storage material for solar power generation is about 240 degrees, it is usually impossible that the temperature of the heat storage material becomes equal to or lower than the solidification point during the rated operation.

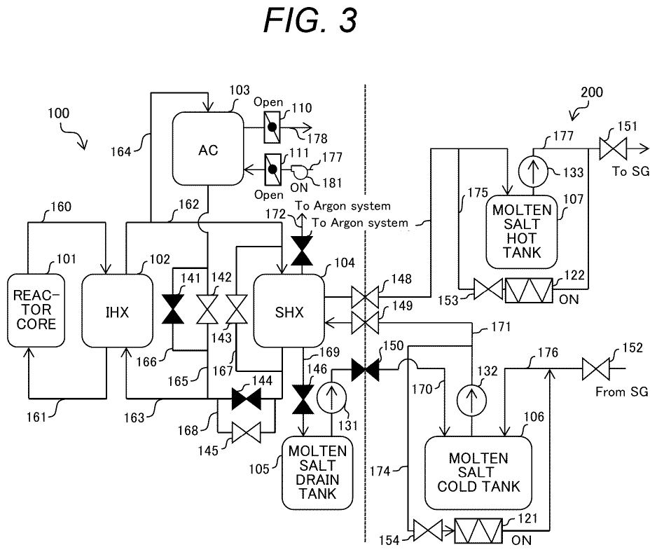

Next, the cold shutdown of the fast reactor will be described. FIG. 3 is a configuration diagram of the fast reactor including the molten salt heat storage system during the cold shutdown. Also in FIG. 3, only main devices are illustrated for concise description.

During the cold shutdown, in a case where it is assumed that the temperature of the coolant is lowered to about 200 degrees while heat removal is performed by natural circulation of the secondary coolant, for example, after a nuclear reactor scram and each main circulation pump trip are performed, the valves of the pipes of the fast reactor 100 are operated such that the valve 141 and the valve 144, which are opened during the rated operation, are closed, and the valve 142 and the valve 145 are opened as illustrated in FIG. 3.

At this time, most of the secondary coolant flows to the AC 103, the blower 181 is turned on, the damper 111 is opened, and the heat removal operation is started according to diameters of the pipe 165 and the pipe 168 on which the valve 142 and the valve 145 in an open state are present.

Here, by opening the bypass valve 143 and allowing a part of the secondary coolant flowing to the SHX 104 to flow to the bypass pipe 167, the inflow amount to the SHX 104 is reduced, and a heat exchange amount with the heat storage material in the tertiary loop is reduced. That is, it is possible to prevent the temperature of the heat storage material from being lowered to a temperature equal to or lower than the solidification point by the secondary coolant cooled to about 200 degrees.

A flow resistance of the SHX 104 itself also contributes to a flow of more secondary coolant to the bypass pipe 167. However, by disposing the bypass pipe 167 at a position lower than the SHX 104 in the vertical direction as illustrated in FIG. 2, the secondary coolant heated by the heat storage material in the SHX 104 has a higher temperature than the secondary coolant passing through the bypass pipe 167, and a density thereof is reduced. Therefore, it is possible to cause the secondary coolant flowing through the SHX 104 to stagnate at a high elevation, thereby making the flow of the secondary coolant more difficult. Therefore, the inflow amount of the secondary coolant into the SHX 104 is further reduced as compared with a case of a pipe arrangement in which the SHX 104 and the bypass pipe are disposed on substantially the same plane. An inflow valve may be throttled.

Here, it is also conceivable to provide a valve on a secondary coolant outlet side of the SHX 104 so that the secondary coolant does not flow into the SHX 104 at all, close the valve during the cold shutdown, and retain the secondary coolant in the SHX 104. However, in this case, the secondary coolant retained in the SHX 104 may be cooled over time due to natural heat release, and the secondary coolant may be solidified. Therefore, it is important to avoid completely eliminating a sodium flow while reducing a flow rate of the secondary coolant flowing through the SHX 104 by providing the bypass pipe 167.

During this period, the molten salt heat storage system 200 can generate power by continuing circulation of the heat storage material in the tertiary loop because heat is removed only slightly from the SHX 104. However, in any case, the temperature of the heat storage material in the molten salt hot tank 107 is made uniform with the temperature of the heat storage material in the molten salt cold tank 106, making it difficult to generate steam in the SG. Therefore, water supply to the SG is stopped at a predetermined timing, the valve 153 and the valve 154 are opened to prevent a decrease in temperature and freezing due to natural heat release, and the heater 121 and the heater 122 are turned on to heat the heat storage material in both tanks.

The fast reactor according to the present invention includes: the first heat exchanger that performs heat exchange between the primary coolant and the secondary coolant; the second heat exchanger that performs heat exchange between the secondary coolant and the heat storage material used in the heat storage system; the first pipe through which the secondary coolant flows from the first heat exchanger toward the second heat exchanger; the second pipe through which the secondary coolant flows from the second heat exchanger toward the first heat exchanger; and the bypass pipe that is provided at an inlet and an outlet of the second heat exchanger for the secondary coolant and couples the first pipe and the second pipe, so that it is possible to provide the fast reactor and a fast reactor operation method capable of suppressing occurrence of freezing of the heat storage material without draining the heat storage material used in the heat storage system connected to the fast reactor when the temperature of the coolant of the fast reactor decreases in an operation mode such as the cold shutdown.

As described above, in the first embodiment, the bypass pipe 167 is provided, and thus, it is possible to prevent solidification of the heat storage material in the SHX 104 without draining the heat storage material to the molten salt drain tank 105. In addition, it is possible not only to eliminate the need for a complicated drain operation only by disposing a bypass route, but also to reduce a time required for drainage, and as a result, it is possible to improve a plant operation rate.

Next, a method of operation switching from the rated operation to the cold shutdown will be described.

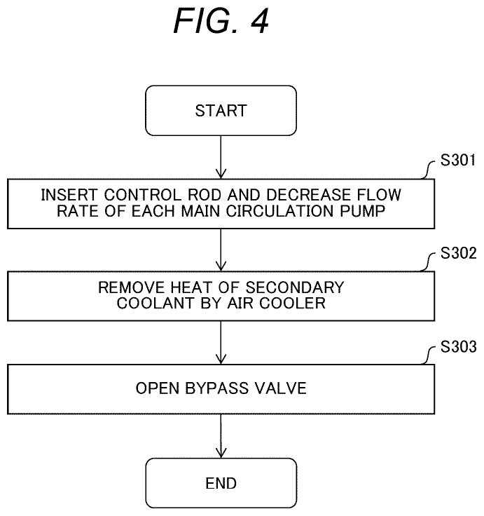

FIG. 4 is a flowchart illustrating a method of operation switching to the cold shutdown for the fast reactor including the molten salt heat storage system. In step S301, first, a control rod (not illustrated) in a nuclear reactor vessel (not illustrated) is inserted into a reactor core by a control rod drive mechanism (not illustrated), and flow rates of the primary main circulation pump and the secondary main circulation pump are decreased while gradually reducing a nuclear reactor output.

In step S302, the heat removal operation by the AC 103 for the purpose of removing the decay heat is started. Specifically, the valve 142 and the valve 145 are opened, the valve 141 and the valve 144 are closed, the blower 181 is turned on, and the damper 111 is opened. The secondary coolant is cooled by the AC 103, and the primary coolant is cooled via the IHX 102, thereby cooling the reactor core.

In step S303, the bypass valve 143 is opened. By changing the bypass valve 143 to the open state, it is possible to minimize the flow rate of the secondary coolant flowing into the SHX 104 as in the above-described embodiment.

By stopping the operation of the fast reactor, removing the heat of the secondary coolant by the air cooler, opening the valve of the bypass pipe provided on the inlet side and outlet side of the heat exchanger, and operating from the rated operation to the cold shutdown, it is possible to minimize the flow rate of the secondary coolant flowing into the SHX 104, which is a method suitable for performing operation switching from the rated operation to the cold shutdown.

### Second Embodiment

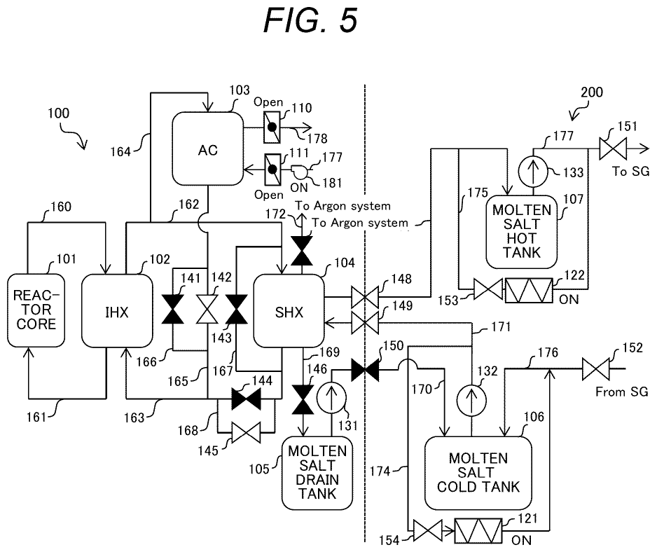

FIG. 5 is a configuration diagram of a fast reactor including a molten salt heat storage system according to a second embodiment. In the present modified example, there is no difference in height between a bypass pipe 167 and an SHX 104. In other words, such an aspect is a more preferable aspect in a case where the bypass pipe 167 and the SHX 104 are disposed on substantially the same plane. Only portions different from the first embodiment will be described.

In the second embodiment, a valve 155 having a flow rate adjustment function is provided on a pipe 163 between the SHX 104 and a connection portion between the bypass pipe 167 and the pipe 163. That is, a valve capable of adjusting a flow rate is provided on a second pipe between a second heat exchanger and a connection portion between a bypass pipe and the second pipe. Solidification of a heat storage material can be prevented by opening the valve 155 during rated operation and controlling the flow rate by adjustment of an opening degree of the valve 155 so that the secondary coolant is not solidified due to natural heat release during a cold shutdown.

The present invention is not limited to the above-described embodiments and includes various modified examples. For example, the above-described embodiments have been described in detail in order to describe the present invention in an easy-to-understand manner, and the present invention is not necessarily limited to those having all the configurations described above. In addition, a part of a configuration of a certain embodiment can be replaced with a configuration of another embodiment, and a configuration of another embodiment can be added to a configuration of a certain embodiment. In addition, for a part of a configuration of each embodiment, it is possible to perform deletion, addition of another configuration, or replacement with another configuration.

What is claimed is:

1. A fast reactor comprising:
a first heat exchanger that performs heat exchange between a primary coolant and a secondary coolant;
a second heat exchanger that performs heat exchange between the secondary coolant and a heat storage material used in a heat storage system;
a first pipe through which the secondary coolant flows from the first heat exchanger toward the second heat exchanger;
a second pipe through which the secondary coolant flows from the second heat exchanger toward the first heat exchanger; and
a bypass pipe that is provided at an inlet and an outlet of the second heat exchanger for the secondary coolant and couples the first pipe and the second pipe.

2. The fast reactor according to claim 1, wherein the second heat exchanger is disposed vertically above the bypass pipe.

3. The fast reactor according to claim 1, wherein a valve that is configured to adjust a flow rate is provided on the second pipe between the second heat exchanger and a connection portion between the bypass pipe and the second pipe.

4. The fast reactor according to claim 1, wherein
a third pipe that couples the first pipe and the second pipe is provided, and
an air cooler is provided on the third pipe.

5. The fast reactor according to claim 1, wherein
the primary coolant and the secondary coolant are sodium, and
the heat storage material is molten salt.

6. A fast reactor operation method for a fast reactor including a first heat exchanger that performs heat exchange between a primary coolant and a secondary coolant, a second heat exchanger that performs heat exchange between the secondary coolant and a heat storage material used in a heat storage system, a first pipe through which the secondary coolant flows from the first heat exchanger toward the second heat exchanger, a second pipe through which the secondary coolant flows from the second heat exchanger toward the first heat exchanger, a bypass pipe that is provided at an inlet and an outlet of the second heat exchanger for the secondary coolant and couples the first pipe and the second pipe, a valve that is configured to adjust a flow rate and provided on the second pipe between the second heat exchanger and a connection portion between the bypass pipe and the second pipe, a third pipe that couples the first pipe and the second pipe, and an air cooler provided on the third pipe, the fast reactor operation method comprising:
stopping operation of the fast reactor;
removing heat of the secondary coolant by the air cooler; and
opening a valve of the bypass pipe and operating from rated operation to a cold shutdown.

7. The fast reactor operation method according to claim 6, wherein a flow rate is controlled by adjusting an opening degree of the valve that is configured to adjust the flow rate and provided on the second pipe.
